(19) United States
(12) Patent Application Publication
(10) Pub. No.: US 2014/0159626 A1
(43) Pub. Date: Jun. 12, 2014

(54) MOTOR DRIVING APPARATUS

(71) Applicant: SAMSUNG ELECTRO-MECHANICS CO., LTD., Suwon (KR)

(72) Inventor: Soo Woong LEE, Gyunggi-do (KR)

(73) Assignee: SAMSUNG ELECTRO-MECHANICS CO., LTD., Suwon (KR)

(21) Appl. No.: 13/779,278

(22) Filed: Feb. 27, 2013

(30) Foreign Application Priority Data
Dec. 12, 2012 (KR) 10-2012-0144131

(51) Int. Cl. H02H 7/08

(52) U.S. Cl. CPC H02H 7/0805
USPC 318/400.22

(57) ABSTRACT

There is provided a motor driving apparatus in which a current is detected from a connection point between a PMOS transistor and an NMOS transistor of a motor driving circuit, thus reducing a voltage headroom loss due to a shunt resistor. The motor driving apparatus including: a driving unit including a first transistor unit and a second transistor unit connected in parallel between a driving power source terminal and a ground; and a motor driven according to switching of the first and second transistor units; and a detection unit detecting a current from a connection point between a PMOS transistor and an NMOS transistor of at least one of the first and second transistor units.

### CROSS-REFERENCE TO RELATED APPLICATIONS

This application claims the priority of Korean Patent Application No. 10-2012-0144131 filed on Dec. 12, 2012, in the Korean Intellectual Property Office, the disclosure of which is incorporated herein by reference.

### BACKGROUND OF THE INVENTION

1. Field of the Invention

The present invention relates to a motor driving apparatus having a protection function for detecting an overcurrent.

2. Description of the Related Art

Recently, the use of electric devices or electronic devices has seen explosive growth due to demand for the use thereof in domestic, commercial and industrial settings.

Such devices may employ a driving circuit for driving a particular operation therein, and a motor may be an example of an element installed in such devices.

In general, a brushless DC (BLDC) motor refers to a DC motor having a function of applying a current to a motor coil or regulating a direction of a current flowing in the motor coil by using a contactless position detector and a semiconductor device, without using mechanical contact portions such as a brush, a commutator, and the like.

In order to drive the BLDC motor, a driving apparatus may be employed.

FIG. 1 is a view illustrating a configuration of a general motor driving apparatus.

Referring to FIG. 1, the general motor driving apparatus 10 may include a controller 11 and a driving unit 12.

The controller 11 may control driving of a motor, and four FETs of the driving unit 12 may be turned on or turned off according to driving signals POUT1, POT2, NOUT1, and NOUT2 from the controller 11, to drive the motor. As illustrated, driving power VDD required for driving the motor may be supplied.

FIG. 2 is a view illustrating the driving signals of the motor driving apparatus.

Referring to FIGS. 1 and 2, driving signals delivered to the driving unit 12 from the controller 11 may be classified into a total of four types of driving signal, and the driving signals may be delivered in order of identification numbers , , , and .

Namely, a first PMOS FET P1 and a second NMOS FET N2 may be turned on by the driving signal, and the first PMOS FET P1 and the second NMOS FET N2 may be turned off while a second PMOS FET P2 and a first NMOS FET N1 may be turned on by the driving signal.

The second PMOS FET P2 and the first NMOS FET N1 may be turned off, while the first PMOS FET P1 and the second NMOS FET N2 may be turned on by the driving signal, and the first PMOS FET P1 and the second NMOS FET N2 are turned off, while the second PMOS FET P2 and the first NMOS FET N1 may be turned on by the driving signal.

In this driving scheme, when the first PMOS FET P1 and the second PMOS FET P2 are turned on, PWM signals (shaded portions in FIG. 2) are generated to regulate a speed of the motor.

The motor driving apparatus may have a problem such as an excessive increase in a motor speed and dielectric breakdown of a circuit due to an overcurrent that may flow in the motor driving circuit, and thus, it may employ an overcurrent detection circuit as described in the related art document mentioned below.

However, in the foregoing overcurrent detection circuit, a current is detected from a shunt resistor having a low resistance value between the motor driving circuit and a ground, causing a voltage headroom loss.

### RELATED ART DOCUMENT

[Patent document 1] Korean Patent Laid Open Publication No. 10-2010-0066119

### SUMMARY OF THE INVENTION

An aspect of the present invention provides a motor driving apparatus in which a current is detected from a connection point between a PMOS transistor and an NMOS transistor of a motor driving circuit, thus reducing a voltage headroom loss due to a shunt resistor.

According to an aspect of the present invention, there is provided a motor driving apparatus including: a driving unit including a first transistor unit and a second transistor unit connected in parallel between a driving power source terminal and a ground, the first transistor unit including a first PMOS transistor and a first NMOS transistor connected in series between the driving power source terminal and the ground, and the second transistor unit including a second PMOS transistor and a second NMOS transistor connected in series between the driving power source terminal and the ground, and a motor connected to a connection point between the first PMOS transistor and the first NMOS transistor and a connection point between the second PMOS transistor and the second NMOS transistor and driven according to switching of the first and second transistor units; and a detection unit detecting a current from a connection point between a PMOS transistor and an NMOS transistor of at least one of the first and second transistor units.

The detection unit may include: a comparator comparing the detected current value with a pre-set reference value; and a path configuration unit connecting or cutting off a signal output path of the comparator according to a switching signal of a corresponding transistor unit.

The detection unit may further include a low pass filter filtering the detected current value by a pre-set frequency band and delivering the same to the comparator.

The path configuration unit may include: a first switch connecting or cutting off a delivery path of the reference value according to a switching signal from a corresponding transistor unit; and a second switch connecting or cutting off a delivery path of an output signal from the comparator according to a switching signal from a corresponding transistor unit.

The first PMOS transistor and the second NMOS transistor may be alternately switched with the second PMOS transistor and the first NMOS transistor.

According to another aspect of the present invention, there is provided a motor driving apparatus including: a driving unit including a first transistor unit and a second transistor unit connected in parallel between a driving power source terminal and a ground, the first transistor unit including a first PMOS transistor and a first NMOS transistor connected in series between the driving power source terminal and the ground, and the second transistor unit including a second PMOS transistor and a second NMOS transistor connected in series between the driving power source terminal and the ground, and a motor connected to a connection point between the first PMOS transistor and the first NMOS transistor and a connection point between the second PMOS transistor and the second NMOS transistor and driven according to switching of the first and second transistor units; a first detection unit detecting a current from the connection point between the first PMOS transistor and the first NMOS transistor of the first transistor unit; and a second detection unit detecting a current from the connection point between the second PMOS transistor and the second NMOS transistor of the second transistor unit.

The first detection unit may include: a first comparator comparing the detected current value with a pre-set reference value; and a first path configuration unit connecting or cutting off a signal output path of the first comparator according to a switching signal of a corresponding transistor unit.

The first detection unit may further include a first low pass filter filtering the detected current value by a pre-set frequency band and delivering the same to the first comparator.

The first path configuration unit may include: a first switch connecting or cutting off a delivery path of the reference value according to a switching signal provided to the second NMOS transistor of the second transistor unit; and a second switch connecting or cutting off a delivery path of an output signal from the first comparator according to a switching signal provided to the first NMOS transistor of the first transistor unit.

The second detection unit may include: a second comparator comparing the detected current value with a pre-set reference value; and a second path configuration unit connecting or cutting off a signal output path of the second comparator according to a switching signal from a corresponding transistor unit.

The second detection unit may further include a second low pass filter filtering the detected current value by a pre-set frequency band and delivering the same to the second comparator.

The second path configuration unit may include: a third switch connecting or cutting off a delivery path of the reference value according to a switching signal provided to the second NMOS transistor of the second transistor unit; and a fourth switch connecting or cutting off a delivery path of an output signal from the second comparator according to a switching signal provided to the first NMOS transistor of the first transistor unit.

The first PMOS transistor and the second NMOS transistor may be alternately switched with the second PMOS transistor and the first NMOS transistor.

According to another aspect of the present invention, there is provided a motor driving apparatus including: a driving unit including a first transistor unit, a second transistor unit, and a third transistor unit connected in parallel between a driving power source terminal and a ground, the first transistor unit including a first PMOS transistor and a first NMOS transistor connected in series between the driving power source terminal and the ground, the second transistor unit including a second PMOS transistor and a second NMOS transistor connected in series between the driving power source terminal and the ground, and the third transistor unit including a third PMOS transistor and a third NMOS transistor connected in series between the driving power source terminal and the ground, and a 3-phase motor connected to a connection point between the first PMOS transistor and the first NMOS transistor, a connection point between the second PMOS transistor and the second NMOS transistor, and a connection point between the third PMOS transistor and the third NMOS transistor, respectively, and driven according to switching of the first to third transistor units; and a detection unit detecting a current from a connection point between a PMOS transistor and an NMOS transistor of at least one of the first to third transistor units.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram of a general motor driving apparatus;

FIG. 2 is a view illustrating driving signals for driving the motor driving apparatus illustrated in FIG. 1;

FIG. 3 is a schematic circuit diagram of a motor driving apparatus according to an embodiment of the present invention;

FIG. 4 is a timing chart of the motor driving apparatus illustrated in FIG. 3;

FIG. 5 is a schematic circuit diagram of a motor driving apparatus according to another embodiment of the present invention; and

FIG. 6 is a schematic circuit diagram of a motor driving apparatus according to another embodiment of the present invention.

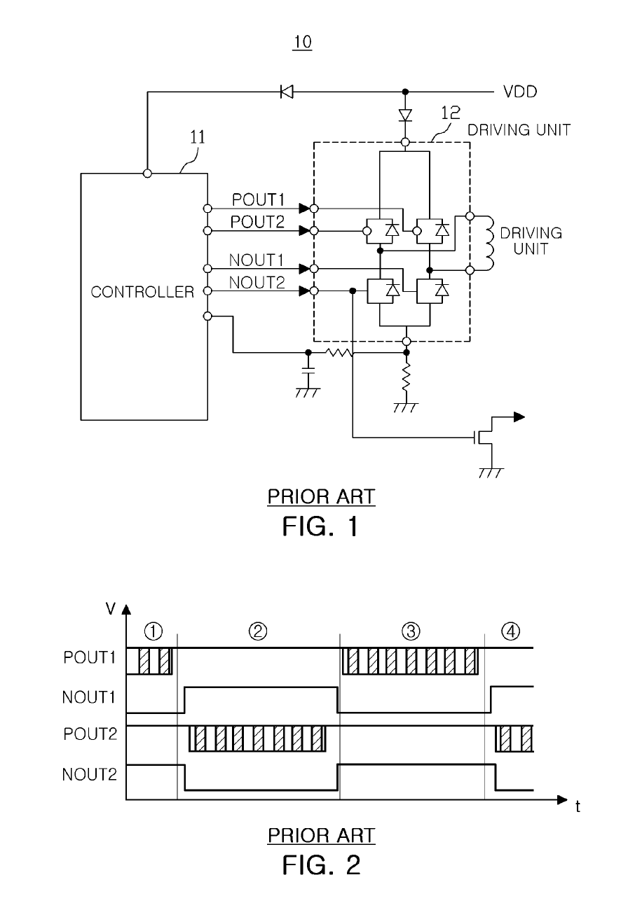

### DETAILED DESCRIPTION OF THE PREFERRED EMBODIMENT

Embodiments of the present invention will now be described in detail with reference to the accompanying drawings.

The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present.

In addition, unless explicitly described to the contrary, the word “comprise” and variations such as “comprises” or “comprising,” will be understood to imply the inclusion of stated elements but not the exclusion of any other elements.

Hereinafter, embodiments of the present invention will be described in detail with reference to the accompanying drawings.

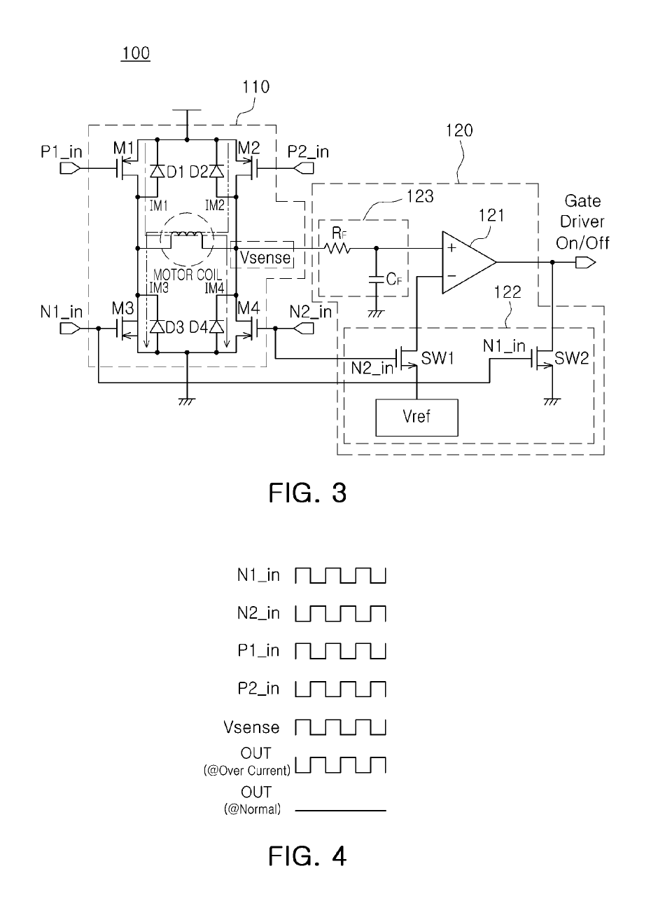

FIG. 3 is a schematic circuit diagram of a motor driving apparatus according to an embodiment of the present invention.

Referring to FIG. 3, a motor driving apparatus 100 according to an embodiment of the present invention may include a driving unit 110 and a detection unit 120.

The driving unit 110 may include a first transistor unit and a second transistor unit.

The first transistor unit may include a first PMOS transistor M1 and a first NMOS transistor M3 connected in parallel between a driving power source terminal and a ground, and the second transistor unit may include a second PMOS transistor M2 and a second NMOS transistor M4 connected in parallel between the driving power source terminal and the ground.

In detail, a source of the first PMOS transistor M1 may be connected to the driving power source terminal, a gate thereof may receive a switching signal P1_in, and a drain thereof may be connected to a drain of the first NMOS transistor M3. A gate of the first NMOS transistor M3 may receive a switching signal N1_in and a source thereof may be connected to the ground.

Similarly, a source of the second PMOS transistor M2 may be connected to the driving power source terminal, a gate thereof may receive a switching signal P2_in, and a drain thereof may be connected to a drain of the second NMOS transistor M4. A gate of the second NMOS transistor may receive a switching signal N2_in, and a source thereof may be connected to the ground.

A motor (or a motor coil) may be connected between a connection point to which the drain of the first PMOS transistor M1 and the source of the first NMOS transistor M3 are connected and a connection point to which the drain of the second PMOS transistor M2 and the source of the second NMOS transistor M4 are connected.

In order to drive the motor, the first PMOS transistor M1 and the second NMOS transistor M4 may be alternately switched with the second PMOS transistor M2 and the first NMOS transistor M3. Namely, when the first PMOS transistor M1 and the second NMOS transistor M4 are switched on, the second PMOS transistor M2 and the first NMOS transistor M3 may be switched off, and when the first PMOS transistor M1 and the second NMOS transistor M4 are switched off, the second PMOS transistor M2 and the first NMOS transistor M3 may be switched off.

The detection unit 120 may detect a current from a connection point of a PMOS transistor and an NMOS transistor of one of the first and second transistor units.

Namely, without employing a shunt resistor for detecting a current, a current may be detected by using turn-on resistance of a PMOS transistor and an NMOS transistor of one of the first and second transistor units.

To this end, the detection unit 120 may include a comparator 121 and a path configuration unit 122, and may further include a low pass filter 123.

The comparator 121 may compare a current value Vsense detected from the connection point between a PMOS transistor and an NMOS transistor of a corresponding transistor unit with a pre-set reference value Vref to detect a current value. When the detected current value corresponds to a normal current, the comparator 121 may transmit a signal for maintaining a driving operation of the driving unit 110, and when the detected current value corresponds to an overcurrent, the comparator 121 may transmit a signal for stopping the driving operation of the driving unit 110. As illustrated, the comparator 121 may detect a current flowing in the motor and the driving unit 110 from the connection point between the second PMOS transistor M2 and the second NMOS transistor M4 of the second transistor unit, but the present invention is not limited thereto.

Meanwhile, a current may not flow in the connection point of a PMOS transistor and an NMOS transistor of a corresponding transistor unit according to a switching signal of the corresponding transistor unit, and thus, the comparator 121 may perform an unwanted comparison operation.

Thus, in order to stabilize a comparison operation and signal output of the comparator 121, the path configuration unit may be provided.

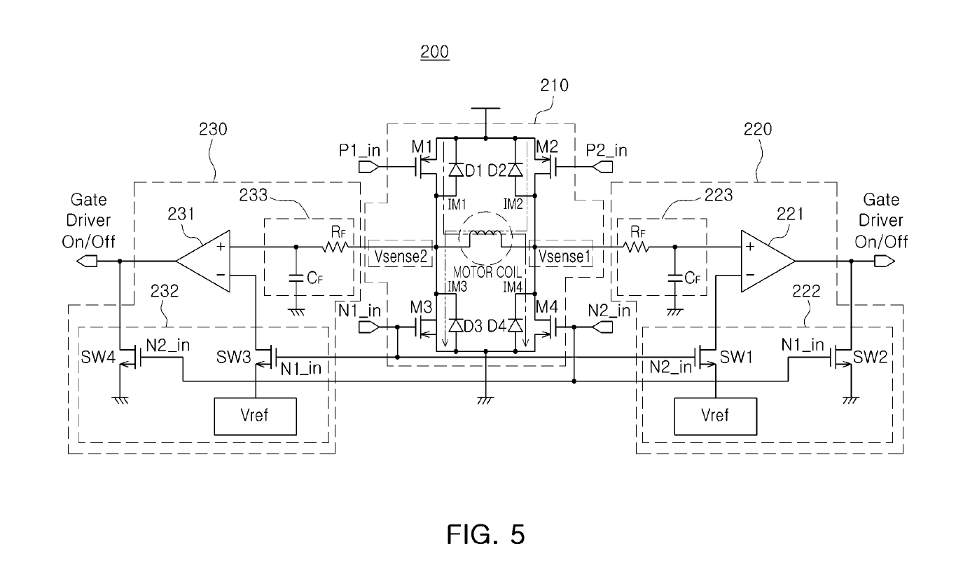

FIG. 4 is a timing chart of the motor driving apparatus illustrated in FIG. 3.

Referring to FIGS. 3 and 4, the path configuration unit 122 may include first and second switches SW1 and SW2, and the first switch SW1 may connect a path along which the reference value Vref is delivered to the comparator 121, or disconnect it according to a switching signal from a corresponding transistor unit, and the second switch SW2 may maintain a signal output from the comparator 121 or cut it off according to a switching signal from a corresponding transistor unit.

Namely, for example, as illustrated, when a current flowing in the motor and the driving unit 110 is detected from the connection point between the second PMOS transistor M2 and the second NMOS transistor M4 of the second transistor unit, the first switch SW1 may be switched on and off according to the switching signal N2_in from the second NMOS transistor M4. Namely, when a current flows in the first PMOS transistor M1 and the second NMOS transistor M4, the first switch SW1 may deliver the reference value Vref to the comparator 121, and when a current does not flow in the first PMOS transistor M1 and the second NMOS transistor M4, the first switch SW1 may cut off delivery of the reference value Vref.

Conversely, the second switch SW2 may be switched on and off according to the switching signal N1_in of the first NMOS transistor M3. Namely, when a current flows in the first PMOS transistor M1 and the second NMOS transistor M4, the first switch SW1 may be switched off to allow an output signal from the comparator 121 to be delivered to the outside, and when a current does not flow in the first PMOS transistor M1 and the second NMOS transistor M4, the first switch SW1 may be switched on to cut off delivery of the output signal from the comparator 121 to the outside.

The low pass filter 123 may include a resistor R_{F} and a capacitor C_{F}. The low pass filter 123 may filter a detected current value Vsense by a pre-set frequency band to deliver a stabilized signal to the comparator 121.

FIG. 5 is a schematic circuit diagram of a motor driving apparatus according to another embodiment of the present invention; and

Referring to FIGS. 3 and 5, a motor driving apparatus 200 according to another embodiment of the present invention may include first and second detection units 220 and 230, unlike the motor driving apparatus 100 according to the former embodiment of the present invention.

A driving unit illustrated in FIG. 5 has the same configuration as that of the driving unit 110 illustrated in FIG. 3, so a detailed description thereof will be omitted.

The first and second detection units 220 and 230 have a configuration similar to that of the detection unit 120 illustrated in FIG. 3. A first comparator 221, a first path configuration unit 222, and a first low pass filter 223 of the first detection unit 220 have the same connection relations and an operation as those of the comparator 121, the path configuration unit 122, and the low pass filter 123. Namely, the first comparator 221, the first path configuration unit 222, and the first low pass filter 223 of the first detection unit 220 may detect a current Vsense1 flowing in a motor and a driving unit 210 from a connection point between the second PMOS transistor M2 and the second NMOS transistor M4 of the second transistor unit and compare the detected current Vsense1 with the reference value.

Also, a second comparator 231, a second path configuration unit 232, and a second low pass filter 233 of the second detection unit 230 have connection relations and an operation similar to those of the first comparator 221, the first path configuration unit 222, and the first low pass filter 223 of the first detection unit 220. Namely, the second comparator 231, the second path configuration unit 232, and the second low pass filter 233 of the second detection unit 230 may detect a current Vsense2 flowing in the motor and the driving unit 210 from the connection point between the first PMOS transistor M1 and the first NMOS transistor M3, and compare the detected current with the reference value Vref.

In addition, the third and fourth switches SW3 and SW4 may be switched on and off according to the switching signal N2_in from the second NMOS transistor M4 and the switching signal N1_in of the first NMOS transistor M3. The third switch SW3 may be switched on and off according to the switching signal N1_in from the first NMOS transistor M4. Namely, when a current flows in the second PMOS transistor M2 and the first NMOS transistor M3, the third switch SW3 may deliver the reference value Vref to the second comparator 231, and when a current does not flow in the second PMOS transistor M2 and the first NMOS transistor M3, the third switch SW3 may cut off delivery of the reference value Vref to the second comparator 231.

Conversely, the fourth switch SW4 may be switched on and off according to the switching signal N2_in from the second NMOS transistor M4. Namely, when a current flows in the second PMOS transistor M2 and the first NMOS transistor M3, the fourth switch SW4 may be switched off to allow an output signal from the second comparator 231 to be delivered to the outside, and when a current does not flow in the second PMOS transistor M2 and the first NMOS transistor M3, the fourth switch SW4 may be switched on to cut off delivery of the output signal from the second comparator 231 to the outside.

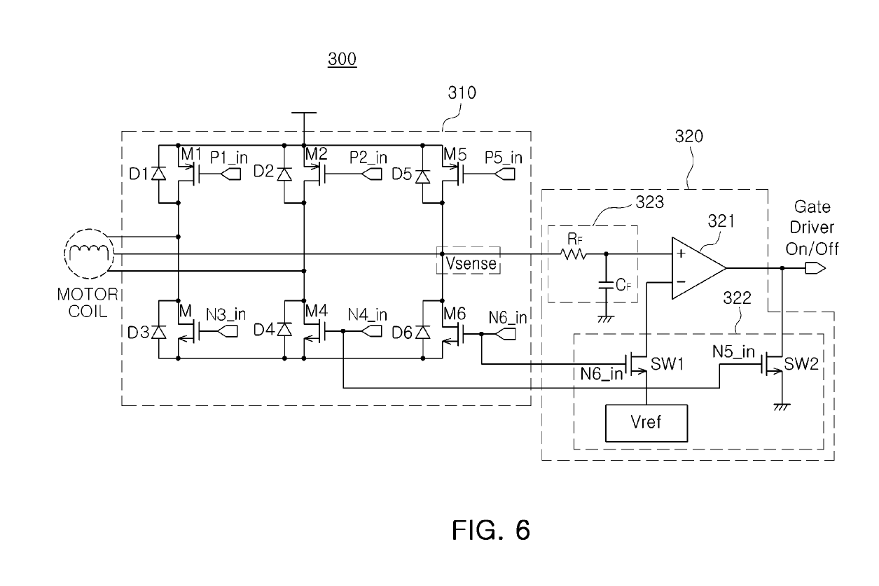

FIG. 6 is a schematic circuit diagram of a motor driving apparatus according to another embodiment of the present invention.

Referring to FIG. 6, a motor driving apparatus 300 according to another embodiment of the present invention may include a driving unit 310 driving a 3-phase motor and a detection unit 320 connected to a connection point of at least one transistor unit of the driving unit 310 to detect a current.

A configuration and operation of a comparator 321, a path configuration unit 322, and a low pass filter 323 of the detection unit 320 are the same as those of the comparator 121, the path configuration unit 122, and the low pass filter 123, so a detailed description thereof will be omitted.

The driving unit 310 may include a first transistor unit (M1, M3), a second transistor unit (M2, M4), and a third transistor unit (M5 and M6) connected between a driving power source terminal to which driving power is input to driving a 3-phase motor and a ground.

Connection relations of the first to third transistor units are the same as or similar to those of FIG. 3 as described above, so a detailed description thereof will be omitted.

The driving unit 310 may include the first to third transistor units corresponding to 3-phase inverter arms, respectively, to drive the 3-phase motor. The detection unit 320 may detect a current from at least one of the connection points between the respective PMOSS transistors M1, M3 and M5 and the respective NMOS transistors M2, M4, and M6 of the first to third transistor units. Although not shown, similarly to the case illustrated in FIG. 5, current may be detected from the respective connection points between the respective PMOS transistors M1, M3, and M5, and the respective NMOS transistors M2, M4, and M6, and to this end, three detection units for detecting currents from the respective connection points may be employed with reference to the configuration of the detection units illustrated in FIGS. 3, 5, and 6.

As set forth above, according to embodiments of the invention, since a current is detected from a connection point between the PMOS transistor and the NMOS transistor of the motor driving circuit, a shunt resistor is not employed, thus reducing voltage headroom lost due to a shunt resistor.

While the present invention has been shown and described in connection with the embodiments, it will be apparent to those skilled in the art that modifications and variations can be made without departing from the spirit and scope of the invention as defined by the appended claims.

What is claimed is:

1. A motor driving apparatus comprising:
a driving unit including a first transistor unit and a second transistor unit connected in parallel between a driving power source terminal and a ground, the first transistor unit including a first PMOS transistor and a first NMOS transistor connected in series between the driving power source terminal and the ground, and the second transistor unit including a second PMOS transistor and a second NMOS transistor connected in series between the driving power source terminal and the ground, and a motor connected to a connection point between the first PMOS transistor and the first NMOS transistor and a connection point between the second PMOS transistor and the second NMOS transistor and driven according to switching of the first and second transistor units; and
a detection unit detecting a current from a connection point between a PMOS transistor and an NMOS transistor of at least one of the first and second transistor units.

2. The motor driving apparatus of claim 1, wherein the detection unit comprises:
a comparator comparing the detected current value with a pre-set reference value; and
a path configuration unit connecting or cutting off a signal output path of the comparator according to a switching signal of a corresponding transistor unit.

3. The motor driving apparatus of claim 2, wherein the detection unit further comprises a low pass filter filtering the detected current value by a pre-set frequency band and delivering the same to the comparator.

4. The motor driving apparatus of claim 2, wherein the path configuration unit comprises:
a first switch connecting or cutting off a delivery path of the reference value according to a switching signal from a corresponding transistor unit; and
a second switch connecting or cutting off a delivery path of an output signal from the comparator according to a switching signal from a corresponding transistor unit.

5. The motor driving apparatus of claim 1, wherein the first PMOS transistor and the second NMOS transistor are alternately switched with the second PMOS transistor and the first NMOS transistor.

6. A motor driving apparatus comprising:
a driving unit including a first transistor unit and a second transistor unit connected in parallel between a driving power source terminal and a ground, the first transistor unit including a first PMOS transistor and a first NMOS transistor connected in series between the driving power source terminal and the ground, and the second transistor unit including a second PMOS transistor and a second NMOS transistor connected in series between the driving power source terminal and the ground, and a motor connected to a connection point between the first PMOS transistor and the first NMOS transistor and a connection point between the second PMOS transistor and the second NMOS transistor and driven according to switching of the first and second transistor units;
a first detection unit detecting a current from the connection point between the first PMOS transistor and the first NMOS transistor of the first transistor unit; and
a second detection unit detecting a current from the connection point between the second PMOS transistor and the second NMOS transistor of the second transistor unit.

7. The motor driving apparatus of claim 6, wherein the first detection unit comprises:
a first comparator comparing the detected current value with a pre-set reference value; and
a first path configuration unit connecting or cutting off a signal output path of the first comparator according to a switching signal of a corresponding transistor unit.

8. The motor driving apparatus of claim 7, wherein the first detection unit further comprises a first low pass filter filtering the detected current value by a pre-set frequency band and delivering the same to the first comparator.

9. The motor driving apparatus of claim 7, wherein the first path configuration unit comprises:
a first switch connecting or cutting off a delivery path of the reference value according to a switching signal provided to the second NMOS transistor of the second transistor unit; and
a second switch connecting or cutting off a delivery path of an output signal from the first comparator according to a switching signal provided to the first NMOS transistor of the first transistor unit.

10. The motor driving apparatus of claim 6, wherein the second detection unit comprises:
a second comparator comparing the detected current value with a pre-set reference value; and
a second path configuration unit connecting or cutting off a signal output path of the second comparator according to a switching signal from a corresponding transistor unit.

11. The motor driving apparatus of claim 10, wherein the second detection unit comprises: a second low pass filter filtering the detected current value by a pre-set frequency band and delivering the same to the second comparator.

12. The motor driving apparatus of claim 10, wherein the second path configuration unit comprises:
a third switch connecting or cutting off a delivery path of the reference value according to a switching signal provided to the second NMOS transistor of the second transistor unit; and
a fourth switch connecting or cutting off a delivery path of an output signal from the second comparator according to a switching signal provided to the first NMOS transistor of the first transistor unit.

13. The motor driving apparatus of claim 6, wherein the first PMOS transistor and the second NMOS transistor are alternately switched with the second PMOS transistor and the first NMOS transistor.

14. A motor driving apparatus comprising:
a driving unit including a first transistor unit, a second transistor unit, and a third transistor unit connected in parallel between a driving power source terminal and a ground, the first transistor unit including a first PMOS transistor and a first NMOS transistor connected in series between the driving power source terminal and the ground, the second transistor unit including a second PMOS transistor and a second NMOS transistor connected in series between the driving power source terminal and the ground, and the third transistor unit including a third PMOS transistor and a third NMOS transistor connected in series between the driving power source terminal and the ground, and a 3-phase motor connected to a connection point between the first PMOS transistor and the first NMOS transistor, a connection point between the second PMOS transistor and the second NMOS transistor, and a connection point between the third PMOS transistor and the third NMOS transistor, respectively, and driven according to switching of the first to third transistor units; and
a detection unit detecting a current from a connection point between a PMOS transistor and an NMOS transistor of at least one of the first to third transistor units.

15. The motor driving apparatus of claim 14, wherein the detection unit comprises:
a comparator comparing the detected current value with a pre-set reference value; and
a path configuration unit connecting or cutting off a signal output path of the comparator according to a switching signal of a corresponding transistor unit.

16. The motor driving apparatus of claim 15, wherein the detection unit further comprises a low pass filter filtering the detected current value by a pre-set frequency band and delivering the same to the comparator.

17. The motor driving apparatus of claim 15, wherein the path configuration unit comprises:
a first switch connecting or cutting off a delivery path of the reference value according to a switching signal from a corresponding transistor unit; and
a second switch connecting or cutting off a delivery path of an output signal from the comparator according to a switching signal from a corresponding transistor unit.

18. The motor driving apparatus of claim 14, wherein the first PMOS transistor and the second NMOS transistor are alternately switched with the second PMOS transistor and the first NMOS transistor.
